(19) United States
(12) Patent Application Publication
(10) Pub. No.: US 2008/0281280 A1
(43) Pub. Date: Nov. 13, 2008

(54) EYEWASH SYSTEM

(75) Inventors: Jeffery S. Jaworski, Sussex, WI (US); Timothy E. Perrin, Hartford, WI (US); Theodore E. Dhein, Sussex, WI (US); Gerard Val Madritsch, Milwaukee, WI (US); Scott W. Beu, Bolingbrook, IL (US); James A. Piper, III, St. Charles, IL (US); Kieron Tse, Batavia, IL (US)

Correspondence Address: FOLEY & LARDNER LLP, 777 EAST WISCONSIN AVENUE, MILWAUKEE, WI, 53202-5306, US

(73) Assignee: Bradley Fixtures Corporation

(21) Appl. No.: 12/061,505

(22) Filed: Apr. 2, 2008

Related U.S. Application Data
(60) Provisional application No. 60/922,076, filed on Apr. 5, 2007.

(51) Int. Cl. A61H 35/02

(52) U.S. Cl. 604/301

(57) ABSTRACT

An eyewash system configured to dispense an eyewash fluid is disclosed. The eyewash system comprises a container configured to contain the eyewash fluid; a cover removably coupled to the container; and one or more projections located at least partially between the container and the cover in a stowed position when the cover is coupled to the container. The one or more projections move to a deployed position when the cover is removed from the container.

### CROSS-REFERENCE TO RELATED APPLICATIONS

The present application claims from U.S. Provisional Patent Application No. 60/922,076 titled “EYEWASH SYSTEM” filed Apr. 5, 2007 (Attorney Docket No. 063359-0396), the full disclosure of which is hereby incorporated herein by reference.

The following U.S. patents and/or patent applications are hereby incorporated herein by reference: U.S. patent application Ser. No. 29/282038 titled “CAP” filed Jul. 10, 2007 (Attorney Docket No. 063359-0406); U.S. patent application Ser. No. 29/282039 titled “EYEWASH SYSTEM” filed Jul. 10, 2007 (Attorney Docket No. 063359-0409).

### BACKGROUND

The present invention relates to an eyewash system.

It is generally known to provide an eyewash system configured for flooding or rinsing of one or both of the eyes of a person (e.g., a worker or other user) with water or a fluid solution in order to remove, dilute, or neutralize a contaminant or other foreign material. One portable type of such eyewash systems typically include a bottle of eyewash fluid/solution and a cap that must be removed (e.g., unscrewed or twisted off) to dispense the eyewash solution. Such known eyewash systems may also have shrink wrap covering the cap that must be removed before the cap can be removed.

It is desired to be able to know whether an eyewash bottle has been opened or used and may even be desired to prevent used eyewash bottles from being reused or refilled after having been used, or otherwise exposed to the environment. However, known eyewash bottle systems have a cap that can be reattached to the bottle after use, refilling, or being separated from the bottle for other reasons.

Accordingly, it would be advantageous to provide an eyewash system with improved sterility by configuration and interaction of its components (e.g., without needing assembly, and/or filling required) and by limiting the system to a single use. It would also be advantageous to provide an eyewash station or system that indicates when the eyewash has been used, re-filled, opened, or otherwise exposed to the environment. It would further be advantageous to provide an eyewash bottle system that indicates when the cover has been separated from the container and/or prevents the cover from being reattached to the container (e.g., single use, tamper-evident, re-seal resistant, etc.). It would further be advantageous to provide an eyewash station that is easier to use and/or set up for use. It would be desirable to provide for an eyewash system having one or more of these or other advantageous features. To provide an inexpensive, reliable, and widely adaptable eyewash system that avoids the above-referenced and other problems would represent a significant advance in the art.

### SUMMARY

An embodiment of the present invention relates to an eyewash system configured to dispense an eyewash fluid. The eyewash system comprises a container configured to contain the eyewash fluid; a cover removably coupled to the container; and one or more projections located at least partially between the container and the cover in a stowed position when the cover is coupled to the container. The one or more projections move to a deployed position when the cover is removed from the container.

Another embodiment of the present invention relates to an eyewash system configured to dispense an eyewash fluid. The eyewash system comprises a container configured to contain the eyewash fluid and including a bottle and a cap located at an outlet of the bottle; a cover removably coupled to the container and at least partially enclosing the cap when the cover is coupled to the container wherein the container may disperse the eyewash fluid when the cover is removed from the container and as inhibited from dispensing the eyewash fluid when the cover is coupled to the container; and one or more projections located at least partially between the container and the cover in a stowed position when the cover is coupled to the container. The one or more projections move to a deployed position when the cover is removed from the container to provide an indicator that indicates that the cover has been removed from the container.

Another embodiment of the present invention relates to a method of assembling an eyewash system configured to dispense an eyewash fluid. The method comprises providing a container, a cover, and one or more projections extending from the container; positioning the one or more projections in a stowed position where the one or more projections are in a biased condition; and removably coupling the cover to the container to retain the one or more projections in the stowed position and the biased condition when the cover is coupled to the container so that the one or more projections move to an deployed position where the one or more projections are in an unbiased condition when the cover is removed from the container.

The present invention further relates to various features and combinations of features shown and described in the disclosed embodiments. Other ways in which the objects and features of the disclosed embodiments are accomplished will be described in the following specification or will become apparent to those skilled in the art after they have read this specification. Such other ways are deemed to fall within the scope of the disclosed embodiments if they fall within the scope of the claims which follow.

### BRIEF DESCRIPTION OF THE FIGURES

FIG. 1 is isometric view of an eyewash system according to an exemplary embodiment.

FIG. 2 is a sectional view of the eyewash system in FIG. 1 according to an exemplary embodiment taken along line 2-2.

FIG. 3 is a sectional view of the eyewash system in FIG. 1 according to an exemplary embodiment with the cover shown removed from the container.

FIG. 4 is an isometric view of the container in FIG. 1 with the cover removed, showing the dispenser portion and the projections in a deployed position according to an exemplary embodiment.

FIG. 5 is a more detailed isometric view of the container in FIG. 4 showing the connection between one of the projections and the lid according to an exemplary embodiment.

FIG. 6 is a sectional view of an eyewash system according to another exemplary embodiment.

Before explaining a number preferred, exemplary, and alternative embodiments of the invention in detail it is to be understood that the invention is not limited to the details of construction and the arrangement of the components set forth in the following description or illustrated in the drawings. The invention is capable of other embodiments or being practiced or carried out in various ways. It is also to be understood that the phraseology and terminology employed herein is for the purpose of description and should not be regarded as limiting.

### DETAILED DESCRIPTION OF EXEMPLARY EMBODIMENTS

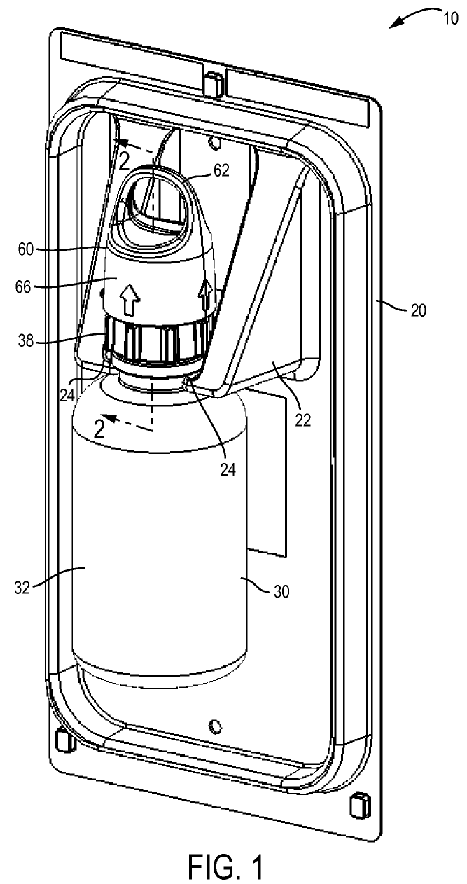

FIG. 1 shows an eyewash system 10 according to a preferred embodiment. The eyewash system 10 includes a base 20 coupled to a mounting surface (e.g., wall, panel, equipment, fixture, etc.) and a container 30 supported by the base 20. The base 20 includes a pair of support arms 22 (e.g., support members, retainers, beams, etc.) that extend outward from the base 20 and form ledges or support surfaces 24 that support the container 30. The container 30 is configured to contain and dispense an eyewash fluid (e.g., to flush a dangerous substance from the eyes or skin of a user). The container 30 is preferably a single-use dispenser and keeps the eyewash fluid sealed and sterile until it is used. The container includes a receptacle or bottle 32, a lid or cap 38 that is coupled to the bottle, and a cover 60 that is releasably coupled to the cap 38. A cover or hood (not shown) may be provided that couples to base 20 and encloses the bottle (e.g., to improve sterility, keep dust or other debris off system 10, etc.).

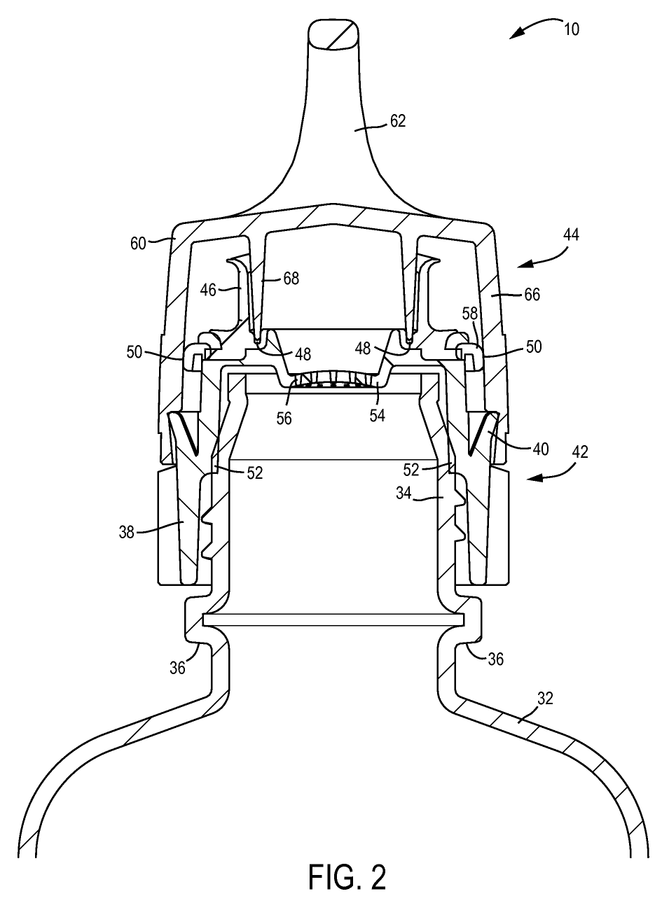

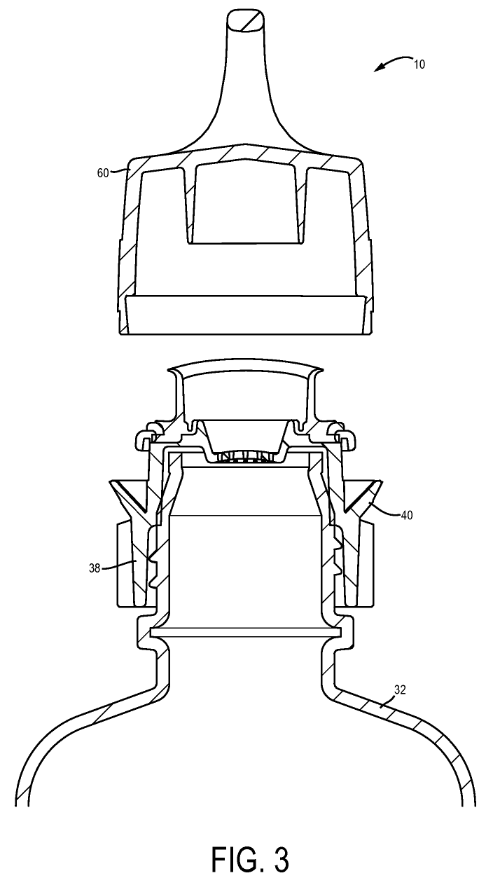

Referring to FIG. 2, the bottle 32 is a generally thin-walled cylindrical body with an open end or outlet 34. The bottle forms an overhang or ledge 36 proximate to the outlet 34 that is supported by the support surfaces 24 on the base 20 when the container is coupled to the base 20 as shown in FIG. 1. Referring to FIGS. 2 and 3, the cap 38 is coupled to the bottle 32 over the outlet 34 and at least partially restricts the flow of the eyewash fluid out of the bottle 32. The cap 38 includes a mounting portion 42 and a dispensing portion 44. The dispensing portion 44 includes an eyecup 46, a nozzle or diffuser 54, and a plurality of seals 48 and 50. The cap 38 includes both rigid and flexible portions. The mounting portion 42 and diffuser 54 are generally rigid while the eyecup 46 and seals 48 and 50 are generally flexible (e.g., resilient, compressible, etc.). The rigid and flexible portions are integrally coupled together by co-molding, insert molding, or another suitable method. According to alternative embodiments, the eyecup may be made from a rigid or semi-rigid material to provide the desired comfort and interface between the user and the container.

According to an exemplary embodiment and shown best in FIG. 2, the mounting portion 42 is a generally cylindrical body that is coupled to the bottle, for example, with a spin weld connection (shown as welded portion 52). The welded portion 52 forms another seal between the cap 38 and the bottle 32. According to a preferred embodiment, welded portion 52 is provided by a spin welding operation. According to other exemplary embodiments, the welded portion 52 may be coupled to the bottle 32 by heat staking, a combination of heat staking and threaded connection, snap-fit connection, adhesive, fastener or any other suitable coupling method or combination of methods.

The diffuser 54 is generally aligned with the outlet 34 and forms one or more openings 56 (e.g. passages, apertures, holes, etc.) that allow the eyewash fluid to escape the bottle 32. In various exemplary embodiments the number, angle, size or arrangement of the openings 56 in the diffuser 54 may be varied to alter the flow rate and pattern of the eye wash. The eyecup 46 is configured to direct the flow of eyewash towards the effected area. The eyecup 46 extends upward from the cap 38 and generally surrounds the diffuser 54. According to an exemplary embodiment, the eyecup 46 and the diffuser 54 are molded in different color plastics to provide a visual contrast as discussed in more detail below and shown best in FIG. 3. According to an exemplary embodiment, the eyecup 46 is a generally elliptical body. According to other exemplary embodiments, the eyecup may be circular, ovoid, rectangular, or the like.

The cover 60 is coupled to the bottle 32 and is configured to prevent the eyewash fluid from (unintentionally) escaping the bottle 32. The cover 60 includes an interface portion 62 and a coupling portion. The interface portion 62 forms a circular member (e.g., handle, loop, ring, etc.) that may be grasped by a user to remove the cover 60 from the bottle 32. The coupling portion comprises a circular side wall 66 that extends downward from the interface portion 62. An inner wall or projection or rib 68 extends downward from the interface portion 62 inside the side wall 66.

A plurality of seals are provided to keep the eyewash fluid contained within the bottle sterile and free of outside contaminants. A first seal 48 between the cover 60 and the cap 38 is formed by a recessed area or groove that is disposed between the eyecup and the diffuser that engages the rib 68 extending downward from the cover 60. A second seal 50 between the cover 60 and the cap 38 is formed by an outwardly extending projection 58 (e.g., flange, flap, lip, etc.). The projection 58 contacts the side wall 66 of the cover 60 to form a “wiper” seal when the cover 60 is in place. A third seal 51 is formed when a portion of the flexible portion of the cap 38 is compressed between a rigid portion of the cap 38 and the bottle 32. According to other exemplary embodiments, one or more of the seals may be formed by o-rings.

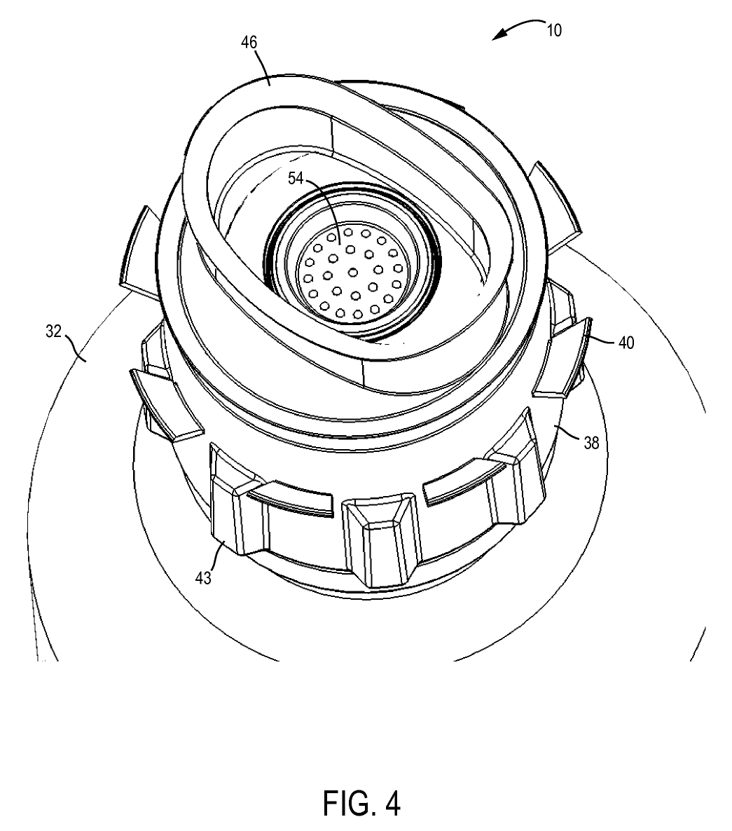

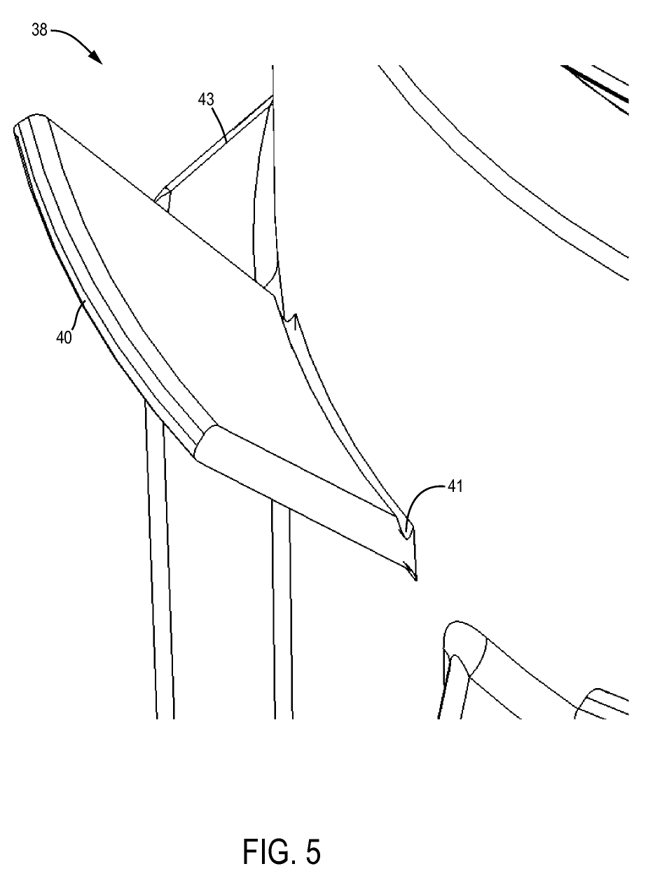

Referring to FIGS. 4 and 5, the cap 38 further includes one or more flaps 40 (e.g., members, projections, petals, indicators, etc.) located between a plurality of ribs 43 extending from cap 38. The flaps 40 extend outward from the outside surface of the cap 38. Deployment of flaps 40 is intended to prevent cover 60 from being reattached to cap 38 to improve sterility of the components. The flaps 40 are generally planar bodies that may include a recessed portion 41 (e.g., groove, notch, relief, etc.) near the base of the flap 40 where it is coupled to the cap 38. As shown in FIG. 2, when the cover 60 is coupled to the cap 38, the flaps 40 are stowed (e.g., biased, flexed, bent, bowed, etc.) towards the outer surface of the cap 38. The flaps 40 push out against the inside surface of the side wall 66 of the coupling portion of the cover 60, creating an interference fit (which at least partially couples the cover 60 to the cap 38) and (with ribs 43) provides an additional seal when the cover 60 is removed from the bottle 32, the flaps 40 move (e.g., reconfigure, reorientate, flex, pivot, rotate, etc.) toward a deployed position (e.g., extended, unbiased, unflexed, straight, etc.) as shown in FIG. 3.

To operate the eyewash system 10, a user removes the container 30 from the base 20 and pulls upward on the interface portion 62 of the cover 60 (i.e., separates the cap from the bottle such as shown by FIGS. 2 and 3). The cover 60 is removed from the cap 38, exposing the eyecup 46 and diffuser 54 (FIG. 4). The user inverts the container 30 and places the eyecup 46 against the affected area, squeezing the bottle allowing the eyewash fluid to flow through the diffuser 54 and flush the affected area. If the affected area is an eye, the different colors of the diffuser 54 and the eyecup 46 provides a visual contrast that helps a user to locate the diffuser, provides a focal point, and keeps the eye open during use. When the cover 60 is removed from the cap 38, the flaps 40 move outward to an unbiased (e.g., unflexed, straight, deployed, extended, etc.) position as shown in FIGS. 3, 4, and 5. The container 30 is intended to be a single-use system and the flaps 40 provide a visual indicator that the cover 60 has been removed. Additionally, the flaps 40 inhibit or prevent the cover 60 from being put back on the container 30. Arrangement and operation of cover 60 and cap 38 (and the associated interfaces and seals) is intended to provide an eyewash system that is easier to use (e.g., does not require assembly, filling, etc.).

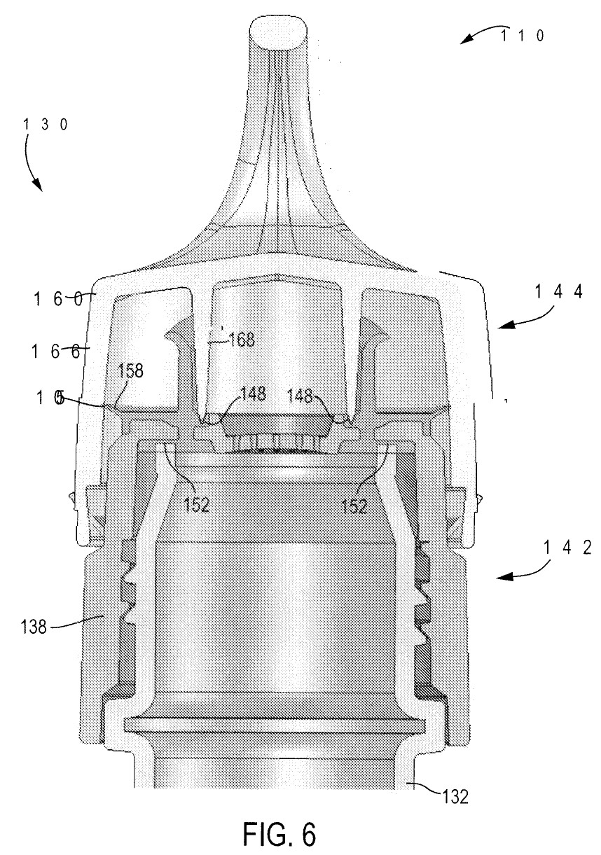

FIG. 6 shows an eyewash system 110 according to another exemplary embodiment. The eyewash system 110 in FIG. 6 is similar to the eyewash system 10 of FIG. 2 and includes a base (not shown) coupled to a mounting surface and a container 130 supported by the base. The container 130 is configured to contain and dispense an eyewash fluid (e.g., to flush a dangerous substance from the eyes or skin of a user). The container 130 is a single-use dispenser and keeps the eyewash fluid sealed and sterile until it is used. The container includes a receptacle or bottle 132, a lid or cap 138 that is coupled to the bottle, and a cover 160 that is releasably coupled to the cap 138.

The cap 138 is coupled to the bottle 132 and at least partially restricts the flow of the eyewash fluid out of the bottle 132. The cap 138 includes a mounting portion 142 and a dispensing portion 144. The mounting portion 142 is a generally cylindrical body that is coupled to the bottle 132 with a threaded connection.

The cap 138 includes both rigid and flexible portions. The rigid and flexible portions are integrally formed as a single unitary body by co-molding, insert molding, or another suitable method. A plurality of seals are provided by the flexible portion of the cap 138 to keep the eyewash fluid contained within the bottle sterile and free of outside contaminants. A first seal 148 between the cover 160 and the cap 138 is formed by a recessed area or groove that is disposed between the eyecup and the diffuser that engages the rib 168 extending downward from the cover 160. A second seal 150 between the cover 160 and the cap 138 is formed by an outwardly extending projection 158 (e.g., flange, flap, lip, etc.). The projection 158 contacts the inside wall 166 of the cover 160 to form a wiper seal. A third seal 152 is formed when a portion of the flexible portion of the cap 138 is compressed between a rigid portion of the cap 138 and the bottle 132.

The particular materials used to construct the exemplary embodiments are also illustrative. For example, injection molded high density polyethylene is the preferred method and material for making the cup and cover; blow molded polyethylene is the preferred method and material for making the bottle; and injection molded thermoplastic rubber (TPR) is the preferred method and material for the eye cup and other flexible portions. Also, the eye cup may be molded into the body of the container, made of casted material, metal, elastomer, or epoxy, but other materials can be used, including other thermoplastic resins such as polypropylene, high density or other polyethylenes, acrylonitrile butadiene styrene (“ABS”), polyurethane, nylon, any of a variety of homopolymer plastics, copolymer plastics, plastics with special additives, filled plastics, etc. Also, other molding operations may be used to form these components, such as blow molding, rotational molding, etc.

It is important to note that the terms used herein are intended to be broad terms and not terms of limitation. These components may be used with any of a variety of products or arrangements and are not intended to be limited to use with emergency eyewash applications. For purposes of this disclosure, the term “coupled” shall mean the joining of two members directly or indirectly to one another. Such joining may be stationary in nature or movable in nature. Such joining may be achieved with the two members or the two members and any additional intermediate members being integrally formed as a single unitary body with one another or with the two members or the two members and any additional intermediate member being attached to one another. Such joining may be permanent in nature or alternatively may be removable or releasable in nature. Such joining may also relate to mechanical, fluid, or electrical relationship between the two components.

It is also important to note that the construction and arrangement of the elements of the eyewash system as shown in the preferred and other exemplary embodiments are illustrative only. Although only a few embodiments of the present invention have been described in detail in this disclosure, those skilled in the art who review this disclosure will readily appreciate that many modifications are possible (e.g., variations in sizes, dimensions, structures, shapes and proportions of the various elements, values of parameters, mounting arrangements, materials, colors, orientations, etc.) without materially departing from the novel teachings and advantages of the subject matter recited in the claims. Accordingly, all such modifications are intended to be included within the scope of the present invention as defined in the appended claims. The order or sequence of any process or method steps may be varied or re-sequenced according to alternative embodiments. In the claims, any means-plus-function clause is intended to cover the structures described herein as performing the recited function and not only structural equivalents but also equivalent structures. Other substitutions, modifications, changes and/or omissions may be made in the design, operating conditions and arrangement of the preferred and other exemplary embodiments without departing from the spirit of the present invention as expressed in the appended claims.

What is claimed is:

1. An eyewash system configured to dispense an eyewash fluid comprising:
a container configured to contain the eyewash fluid;
a cover removably coupled to the container;
one or more projections located at least partially between the container and the cover in a stowed position when the cover is coupled to the container;
wherein the one or more projections move to a deployed position when the cover is removed from the container.

2. The eyewash system of claim 1 wherein the one or more projections are in a biased condition when in the stowed position, and are in an unbiased condition when in the deployed position.

3. The eyewash system of claim 2 wherein the one or more projections inhibit the cover from being coupled to the container after having been removed from the container.

4. The eyewash system of claim 2 wherein the one or more projections extend outwardly from a surface of the container.

5. The eyewash system of claim 2 wherein the one or more projections are bent against the container when the cover is coupled to the container.

6. The eyewash system of claim 5 wherein the one or more projections comprise a plurality of spaced apart projections.

7. The eyewash system of claim 2 wherein the cover comprises an interface portion formed by a ring member that a user can grasp and pull to separate the cover from the container.

8. The eyewash system of claim 2 wherein the one or more projections provide an indicator that indicates that the cover has been removed from the container.

9. The eyewash system of claim 1 wherein the container comprises an eyecup and a nozzle through which the eyewash fluid exits the container during use, wherein the nozzle and the eyecup are different colors to provide a focal point for an eye of a user of the eyewash system and assist to the user in keeping his/her eye open.

10. The eyewash system of claim 1 wherein the container may dispense the eyewash fluid when the cover is removed from the container and as inhibited from dispensing the eyewash fluid when the cover is coupled to the container.

11. The eyewash system of claim 1 further comprising a base with a pair of support arms configured to support the container.

12. An eyewash system configured to dispense an eyewash fluid comprising:
a container configured to contain the eyewash fluid, the container including a bottle and a cap located at an outlet of the bottle;
a cover removably coupled to the container and at least partially enclosing the cap when the cover is coupled to the container wherein the container may disperse the eyewash fluid when the cover is removed from the container and as inhibited from dispensing the eyewash fluid when the cover is coupled to the container;
one or more projections located at least partially between the container and the cover in a stowed position when the cover is coupled to the container;
wherein the one or more projections move to a deployed position when the cover is removed from the container to provide an indicator that indicates that the cover has been removed from the container.

13. The eyewash system of claim 12 wherein the one or more projections are in a biased condition when the stowed position, and are in an unbiased condition when in the deployed position.

14. The eyewash system of claim 12 wherein the cap comprises an eyecup located at an outlet of the container and the cover is configured to substantially enclose the eyecup when the cover is coupled to the container.

15. The eyewash system of claim 14 wherein the eyecup is ovular, circular, or elliptical.

16. The eyewash system of claim 12 wherein the cap comprises a mounting portion and a dispenser portion.

17. The eyewash system of claim 16 wherein the dispenser portion comprises an eyecup and a nozzle through which the eyewash fluid exits the container during use.

18. The eyewash system of claim 17 wherein the eyecup is made of a flexible material and the mounting portion is made of a rigid material.

19. The eyewash system of claim 17 wherein the nozzle and the eyecup are different colors to provide a focal point for an eye of a user of the eyewash system, which assists the user in keeping his/her eye open.

20. The eyewash system of claim 12 wherein the cap comprises a flexible portion and a rigid portion.

21. The eyewash system of claim 20 wherein the flexible portion comprises an eyecup, a seal between the rigid portion and the bottle, and a first seal between the cap and the cover that is formed by a projection that engages the cover when the cover is coupled to the container.

22. The eyewash system of claim 21 wherein the cover includes a rib that engages the flexible portion of the cap to provide a second seal between the cap and the cover so that the eyewash fluid is maintained in a sterile condition and does not leak out of the container.

23. The eyewash system of claim 21 wherein the flexible portion and the rigid portion are integrally formed by co-molding or by insert molding.

24. The eyewash system of claim 12 wherein the cap is coupled to the bottle by at least one of a threaded engagement, heat staking, thermal bonding, solvent bonding, or adhesive bonding.

25. An eyewash system configured to dispense an eyewash fluid comprising:
a container configured to contain the eyewash fluid and including;
a dispenser portion providing an outlet to the container, the dispenser portion having an eyecup and a nozzle through which the eyewash fluid exits the container during use;
wherein the nozzle and the eyecup are different colors to provide a focal point for an eye of a user of the eyewash system, which assists the user in keeping his/her eye open.

26. The eyewash system of claim 25 wherein the eyecup is made of a flexible material and the nozzle is made of a rigid material.

27. The eyewash system of claim 25 wherein the dispenser portion comprises a flexible portion and a rigid portion.

28. The eyewash system of claim 27 further comprising a cover removably coupled to the container and at least partially enclosing the cap and inhibiting dispensing of the eyewash fluid when the cover is coupled to the container, wherein the flexible portion comprises the eyecup, a first seal between the rigid portion and the bottle, and a second seal between the dispenser portion and the cover that is formed by a projection that engages the cover when the cover is coupled to the container.

29. The eyewash system of claim 28 wherein the cover includes a rib that engages the flexible portion of the cap to provide a second seal between the cap and the cover so that the eyewash fluid is maintained in a sterile condition and does not leak out of the container.

30. The eyewash system of claim 27 wherein the flexible portion and the rigid portion are integrally formed by co-molding or by insert molding.

31. The eyewash system of claim 25 further comprising one or more projections located at least partially between the container and the cover in a stowed position when the cover is coupled to the container, wherein the one or more projections move to a deployed position when the cover is removed from the container to provide an indicator that indicates that the cover has been removed from the container.

32. A method of assembling an eyewash system configured to dispense an eyewash fluid, the method comprising:
providing a container, a cover, and one or more projections extending from the container;
positioning the one or more projections in a stowed position where the one or more projections are in a biased condition;
removably coupling the cover to the container to retain the one or more projections in the stowed position and the biased condition when the cover is coupled to the container so that the one or more projections move to an deployed position where the one or more projections are in an unbiased condition when the cover is removed from the container.

33. The method of claim 32 further comprising the steps of providing a cap having the one or more projections, and coupling the cap to the container before removably coupling the cover to the container.
